(19) United States
(12) Patent Application Publication
(10) Pub. No.: US 2011/0258657 A1
(43) Pub. Date: Oct. 20, 2011

(54) System and method for secured digital video broadcasting of instantaneous testimony

(76) Inventors: Allan Casilao, Glendale, CA (US); Tito Bautista, Rancho Cucamonga, CA (US); Donald Iwuchukwu, Los Angeles, CA (US)

(21) Appl. No.: 12/799,069

(22) Filed: Apr. 17, 2010

(51) Int. Cl. H04N 7/167

(52) U.S. Cl. 725/31

(57) ABSTRACT

A method and apparatus for securely broadcasting an instantaneous deposition testimony video stream is provided. The method includes capturing a witness's testimony via video, audio and text, authenticating the testimony, transmitting the testimony instantaneously to authorized subscribers, viewers and participants remotely located from the deposition through a peer-to-peer network connection using the Internet. Accordingly, the invention allows subscribing attorneys to interactively access and save the textual, video and audio deposition contents, while also allowing interactive communication between the deposing attorney and attorneys or colleagues at the home-office or other remote locations, during the deposition.

### FIELD OF INVENTION

The present invention relates to broadcast communication methods and systems, and more specifically to systems and methods for providing secure peer-to-peer video and audio broadcast of instantaneous witness deposition testimony using the Internet.

### BACKGROUND OF THE INVENTION

### Description of the Related Art

In general, a court reporter, stenotype reporter, voice writer or stenomask writer is a person whose occupation is to transcribe spoken or recorded speech into written form, typically using machine shorthand or a voice silencer and digital recorder to produce official transcripts of court hearings, depositions and other official proceedings. There are two major methods of live person court reporting, machine shorthand and voice writing. Machine shorthand allows the stenotype reporter to keep up with the flow of speech so that no words are missed. The voice writer, on the other hand, repeats verbatim what attorneys, witnesses, and others are saying in a proceeding. In the United States, the court reporter is often also a notary public who is authorized to administer oaths to witnesses, and who certifies that her or his transcript of the proceedings is a verbatim account of what was said.

Witness testimonies are key components of our legal system. Most testimonies are done in court proceedings, but a substantial number are done outside of courtrooms.

In the legal system, a deposition is witness testimony given under oath and recorded for use in court at a later date. In many countries, depositions are given in courtrooms. In the United States, they are usually taken elsewhere. In the United States, it is a part of the discovery process in which litigants gather information in preparation for trial.

In this regard, depositions involve an examining attorney or attorneys whom ask questions and a witness who must answer, i.e. testify, while under oath. The examining attorney's questions and the witness's related answers are recorded by the court reporter, typically using a stenographic recorder.

Audio or video recordings of the examination before trial are commonly taken as well. Thereafter, the court reporter makes a verbatim stenographic record of all that is said during the examination before trial, in the same manner that witness testimony is recorded in court. Prior to taking a deposition, the court reporter administers the same oath or affirmation that the deponent would take if the testimony were being given in court in front of a judge and jury.

Currently attorneys are unable to access and save interactively both the video, audio and documents and are unable to interact with their colleagues and principals outside the deposition room as the deposition occurs. Furthermore, attorneys are currently unable to capture the video of the deposition without a videographer.

Accordingly, there is a void in providing interactive access to depositions during witness testimonies wherein associate attorneys and other concerned parties can view and at the same time participate in the proceedings.

### SUMMARY OF THE INVENTION

The present invention is directed to methods and systems for providing a secure peer-to-peer broadcast of instantaneous witness deposition testimony using the Internet

Additional features and advantages of the invention will be set forth in the description which follows, and in part will be apparent from the description, or may be learned by practice of the invention. The objectives and other advantages of the invention will be realized and attained by the method and structure particularly pointed out in the written description and claims hereof, as well as the appended drawings.

To achieve these and other advantages and in accordance with the purpose of the present invention, as embodied and broadly described, a method for securely broadcasting a witness's textual testimony is provided.

In one embodiment of the present invention, a method for privately broadcasting a video stream during an instantaneous witness deposition testimony via the Internet, includes: authenticating a host laptop computer, capturing the witness deposition testimony via a video capture apparatus, transmitting the captured deposition testimony to the host laptop computer, encrypting the captured deposition testimony video stream for streaming via a remote server to an associate computer in a remote location, decrypting the captured deposition testimony video stream from the host laptop computer for broadcasting on the associate computer, and transmitting an instantaneous message between the host computer and the associate computer during the witness deposition testimony.

Preferably, a security dongle device is attached to the host laptop computer for login to the remote server and authenticating the host computer, wherein the remote server transmits a first security token to the authenticated laptop computer.

The remote server transmits a first security token to the authenticated host laptop computer, wherein the host computer retrieves from the security dongle an ID code, and generates a two-key passphrase. Furthermore, the host computer uses the two-key passphrase to encrypt the captured deposition testimony. Moreover, the associate computer uses the two-key passphrase to decrypt and display the deposition testimony audio and video stream.

The method further includes, capturing the witness deposition testimony via a stenograph device, capturing the witness deposition testimony via an audio recording device; and transmitting a stenograph text, audio and video of the deposition testimony to the host computer, wherein the stenograph text, audio and video of the deposition testimony are encrypted for streaming to the associate computer, and decrypted by the associate computer for broadcasting on the associate computer.

The host laptop computer captures the deposition testimony video stream in JPEG format, and encrypts each JPEG file using the two-key passphrase.

In another embodiment of the present invention, a method of securely broadcasting a video stream of an instantaneous deposition testimony via an Internet network is provided. The method includes authenticating a subscribing user host computer to transmit instantaneous deposition testimony, and a subscribing user associate computer for receiving and broadcasting the instantaneous deposition testimony, recording an instantaneous witness deposition via a stenograph device, capturing an instantaneous witness deposition via a video and audio device, receiving the instantaneous witness deposition video audio and text content by the subscribing user host computer, encrypting the instantaneous witness deposition text, and transmitting the encrypted video audio and text content via the Internet network to the subscribing user associate computer for instantaneous displaying therein.

The instantaneous witness deposition video audio and text content are broadcast to the subscribing user associate computer for interactive communication with the subscribing user host computer during the deposition, wherein the user associate computer is located at a remote location from the deposition location.

In accordance with a further aspect of the invention, authenticating the subscribing user computer includes inserting a security dongle into the subscribing user host computer for login and accessing a remote server via the Internet network, retrieving from the security dongle an ID code, wherein the remote server authenticates the subscribing user host computer and transmits a first security token to the subscribing user host computer, and generating a two-key passphrase using the received first security token and the dongle ID, wherein the two-key passphrase is used for secure broadcast transmission. The two-key passphrase is stored in the security dongle.

Furthermore, authenticating the subscribing user associate computer further includes accessing the remote server and requesting authorization from the subscribing user host computer for a peer-to-peer connection between the subscribing host computer and associate computer, wherein the subscribing user host computer authorizes the peer-to-peer connection and sends to the subscribing user associate computer the two-key passphrase, then the subscribing user associate computer receives an encrypted text stream, decrypts the text stream using the two-key passphrase and displays the instantaneous witness deposition text on the subscribing user associate computer. Moreover, the subscribing user host computer is a laptop computer.

The host laptop computer captures the deposition testimony video stream in JPEG format, and encrypts each JPEG file using the two-key passphrase.

In another aspect of the invention, the method further includes transmitting an instantaneous message between the host computer and the associate computer during the witness deposition testimony, wherein the transmitting computer encrypts each message using the two-key passphrase, then the receiving computer decrypts the message for display thereon.

In another embodiment of the present invention, a secure broadcasting system for an instantaneous deposition testimony is provided. The broadcasting system includes a video and audio recording device for capturing the instantaneous deposition testimony, a stenograph device for capturing the instantaneous deposition testimony, a user host computer connected to the stenograph device, a data transmission system, wherein the transmission system transmits an encrypted instantaneous deposition testimony video, audio and text via an Internet network, and a user associate computer for receiving the encrypted video, audio and text content of the instantaneous deposition testimony at a remote location, decrypting the instantaneous deposition testimony and broadcasting the instantaneous deposition testimony.

In accordance with another aspect of the invention, the data transmission system comprises a security dongle attachable to the subscribing user host computer, a software program that detects the attached security dongle and login to a remote server via the Internet network, wherein the remote server authenticates the subscribing user host computer and transmits a first security token to the user host computer.

The user host computer retrieves from the security dongle an ID code and generates a two-key passphrase for encrypting the captured instantaneous video, audio and text. When the user associate computer requests authentication from the host computer for a peer-to-peer connection between the user host computer and the associate computer, the host user computer sends the two-key passphrase to the associate user computer for decrypting the video, audio and text.

In accordance with a preferred aspect of the present invention, the user host computer is a laptop computer. Furthermore, the user associate computer may be networked to a plurality of associate computers.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a unit of this specification, illustrate embodiments of the invention and together with the description serve to explain the principles of the invention.

FIG. 1 illustrates a secured deposition broadcasting system utilizing an Internet network in accordance with a preferred embodiment of the present invention.

FIG. 2 is a schematic illustration of a subscribing host-attorney's laptop for receiving and securing the captured witness's testimony.

FIG. 3 is a flow chart illustrating the authentication process between the subscribing host-attorney's laptop and a remote server.

FIG. 4 is a flow chart illustrating the authentication process between the subscribing host-attorney's laptop and a remote associate's computer.

FIG. 5 is a schematic illustration of the subscriber associate routing system at a remote location.

### DETAILED DESCRIPTION OF THE PREFERRED EMBODIMENTS

The present invention relates to a broadcasting method of an instantaneous witness deposition. Preferably, a witness testimony is captured during a legal deposition by a court stenographer and videographer, and using a broadcast subscription system the deposition testimony is transmitted to a subscribing examining or deposing attorney's laptop computer for streaming to the examining attorney's associate attorneys or colleagues located at a different location.

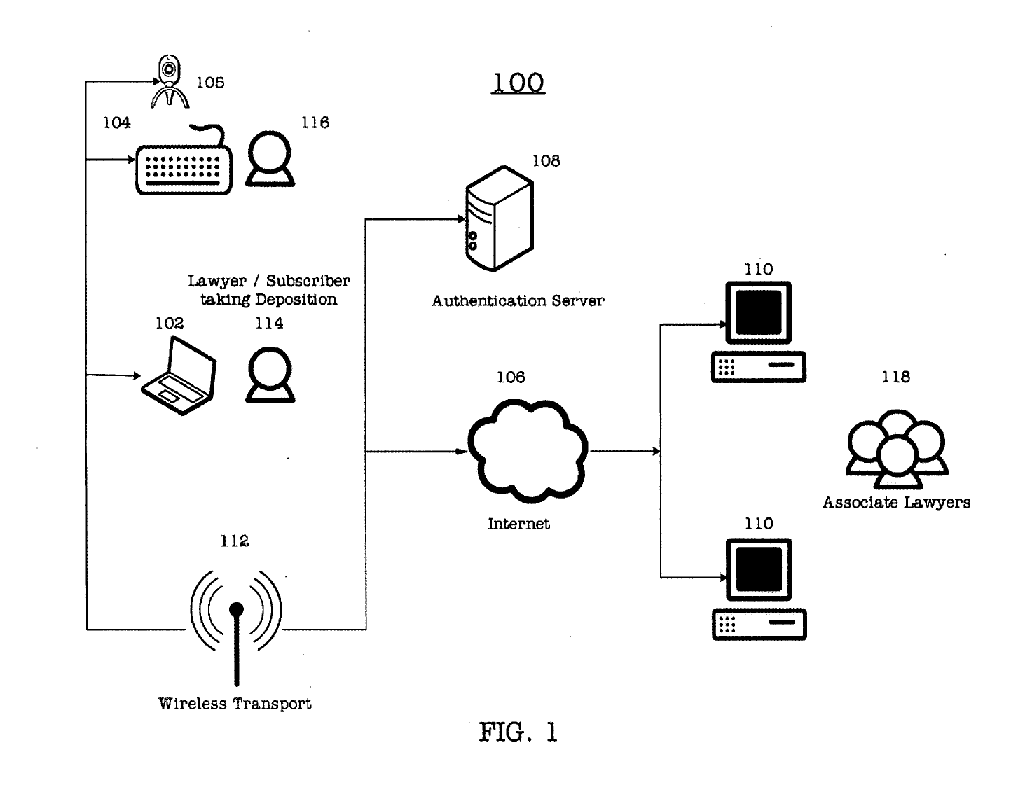

As illustrated in FIG. 1, a secure broadcasting deposition system 100 includes the subscribing attorney's host laptop computer 102 connected to a video recording device 105, stenograph device 104 or court reporter's laptop computer. The attorney's laptop computer 102 can be connected to the stenograph device 104 using a universal asynchronous serial port cable. It is contemplated that the connection can also be accomplished using other contemporary communication system connections known in the art.

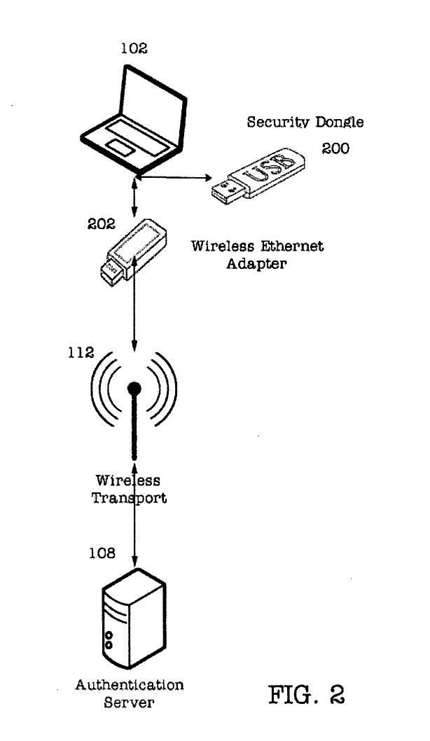

Initially, the examining attorney 114 configures the attorney's laptop computer 102 and software to transmit in the universal ASCII format to the laptop serial port, before the court reporter 116 starts the deposition session. Referring to FIG. 2, the attorney's host laptop 102 is connected to the Internet through either a wired Internet connection provided at the deposition location or through a WI-FI wireless adapter 202, for transporting video frames from a video recording device or web camera 105.

In a preferred embodiment of the present invention, a security dongle device 200 is attached to the attorney's laptop 102. When the subscribing examining attorney 114 opens the broadcast software program, the security dongle 200 is detected and the laptop computer 102 automatically login to a remote server 108 via the Internet 106. The remote server 108 authenticates the attorney's host laptop computer 102 for use in the secure broadcasting deposition system 100. Furthermore, the remote server 108 updates the subscriber's data base.

In general, a dongle device is attached to a computer to make a secured software operate. The dongle device technology prevents the unauthorized copying and pirating of a software program. While dongles typically attach via a computer's serial port, modern dongle technology utilizes a computer's Universal Serial Bus (USB) port. As depicted in FIG. 2, the security dongle 200 configuration may be equivalent to a portable flash drive device. Alternatively, the dongle 200 may be configured as another small USB device.

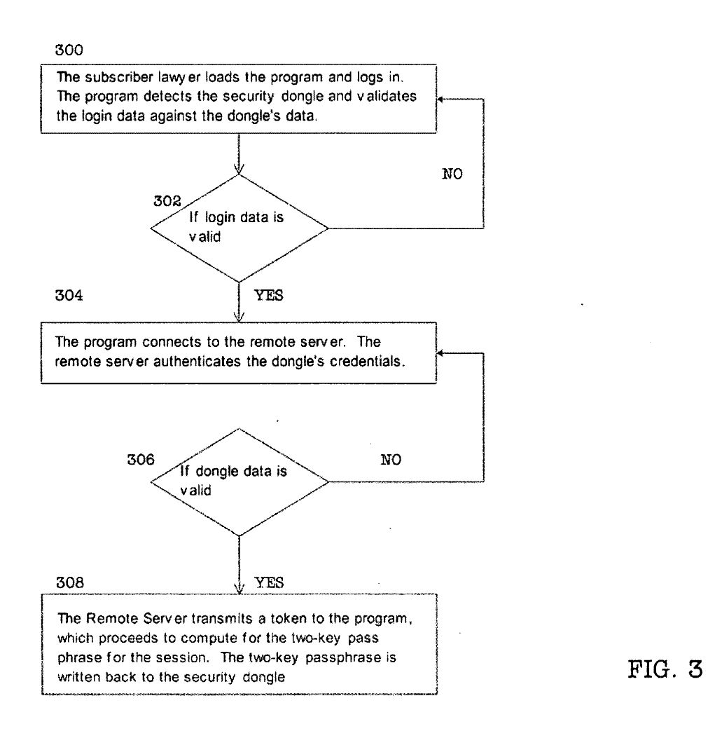

In accordance with an embodiment of the present invention, FIG. 3 illustrates a preferred method for authenticating the subscribing attorney's host laptop computer 102 for video broadcast use.

In the authentication method step 300, the subscribing examining attorney 114 loads the software and login to the remote server after the program detects the security dongle 200 and validates the login data against the dongle 200. In step 302, if the data is determined to be valid, then the program connects to the remote server 108, wherein the remote server authenticates the dongle 200 credentials, step 304. In step 306, when the dongle data is determined to be valid, then the remote server 108 transmits a first security token to the subscribing attorney's laptop computer 102, wherein the software program proceeds to compute or generate a second security token for a two-key passphrase which is provided for the subscription broadcast session, step 308.

Upon receipt of the first security token, the attorney's host laptop computer 102 retrieves from the security dongle 200 a unique dongle ID code. The dongle ID code is used as a validation key to insure security of the software. The laptop computer software generates a second security token for the two-key passphrase. The two-key passphrase is written back to and stored in the security dongle 200.

In a preferred aspect of the present invention, the subscribing examining attorney's host laptop computer 102 is authenticated to transmit instantaneous deposition testimony to the examining attorney's associate attorneys or colleagues 118 in a secured peer-to-peer connection. Using the examining attorney's laptop computer IP address, the associate attorney computer 110 located in a remote location different from the deposition accesses the Internet and requests authorization from the examining attorney's laptop computer 102 for the peer-to-peer communication.

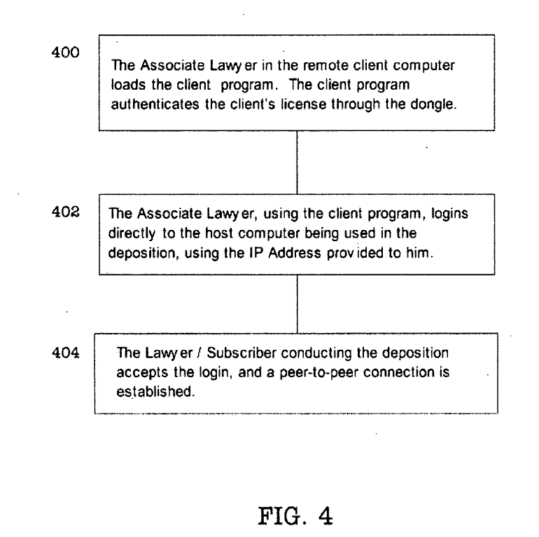

In accordance with the method illustrated in FIG. 4, the associate attorney 118 loads broadcast software on the associate computer 110. The broadcast program authenticates the client's license through the security dongle 200, step 400. In step 402, the associate attorney 118 uses the host computer IP address to login directly to the host computer 102. In step 404, the subscribing examining attorney 114 conducting the deposition authorizes the login request to establish a peer-to-peer connection between the subscribing host and associate computers.

Those skilled in the art will acknowledge that the examining attorney's laptop computer 102 can alternative be a desk top computer, a personal handheld computing device or other computing device.

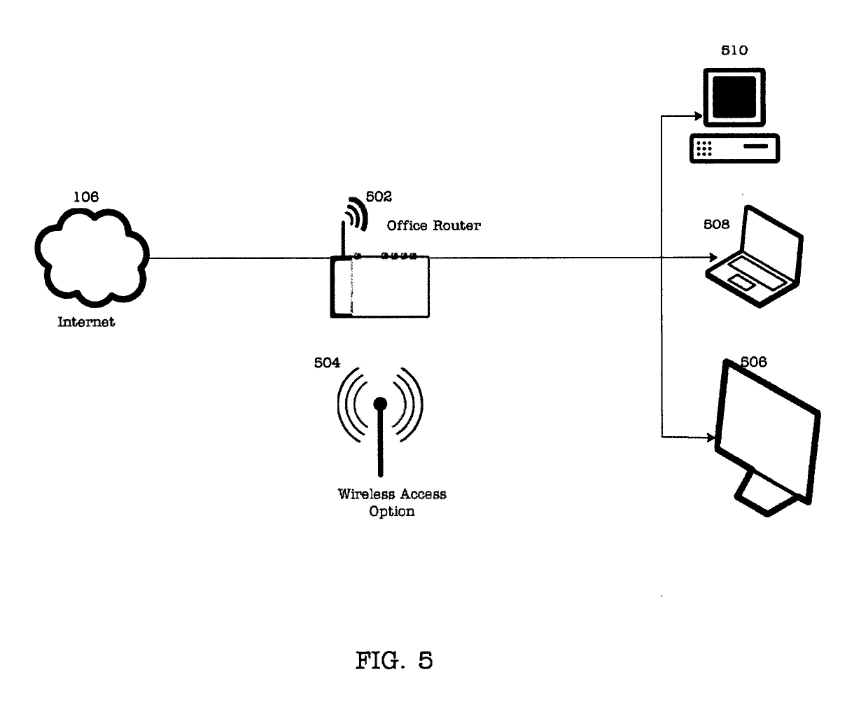

Furthermore, the associate attorney computer 110 may consist of a plurality of associate computers networked together. FIG. 5 is a schematic illustration of a subscriber associate attorney routing system 500 at a remote location. The subscriber associate attorney routing system provides an office router 502 in communication with the Internet 106 via a wireless adapter 504. The router 502 provides data streams to various data mediums, including an associate computer 510, an associate laptop computer 508, and a data projection device or broadcast device 506.

In practice, in a legal deposition a video camera or web camera 105 records an examining attorney 114 asking a witness 116 questions while a court reporter (not shown) keys or inputs the answers into a stenograph device or the court reporters laptop computer 104. The captured video and the text being keyed in by the court reporter are received by a server program installed in the authenticated subscriber attorney's host laptop computer 102. The server program then encrypts the captured video and text using a two-key passphrase, then transmits the encrypted video and text stream to a peer-to-peer associate attorney computer 110. The associate computer 110 receives the encrypted video and text, then decrypts video and text, and displays the video and text stream on the associate computers 110.

Preferably, the subscriber attorney's host laptop computer 102 receives audio content, video and text of the instantaneous deposition session for broadcasting on the subscribing associate attorney computer network. The subscribing attorney with the host laptop computer 102 prepares the witness for the deposition and starts the video stream process.

Video is captured by a video/audio capture apparatus 105 in JPEG format at the rate of 27 frames per second. The capture software module encrypts each JPEG file using the two-key passphrase, then transmits the encrypted file to the associate attorney computer 110. The associate client computer 110 receives and decrypts each JPEG file and plays the video stream thereon.

In still another aspect of the present invention, the secure broadcasting deposition system 100 further includes a module that enables the subscribing host laptop computer 102 to exchange messages with the associate computers 110. Once the subscribing computers 102 and 110 are authenticated, the peer-to-peer connection is established, and video is streaming, then the associate computer 110 can send comments and supplemental questions to the examining attorney in regards. Using the two-key passphrase, the system 100 encrypts the senders message and decrypts the message at the receiver's computer.

While the invention has been shown and described with reference to a certain embodiment thereof, it will be understood by those skilled in the art that various changes may be made therein without departing from the spirit and scope of the invention as defined by the appended claims. Variations described for the present invention can be realized in any combination desirable for each particular application. Thus, particular limitations, and/or embodiment enhancements described herein, which may have particular advantages to a particular application need not be used for all applications. Also, not all limitations need be implemented in methods, systems and/or apparatus including one or more concepts of the present invention.

The present invention can be embodied in a combination of hardware and software. A visualization tool according to the present invention can be realized in a centralized structure in two or more connected computer systems, or in a distributed structure where different elements are spread across several interconnected computer systems. Any kind of computer system or other apparatus adapted for carrying out the methods and/or functions described herein is suitable. A typical combination of hardware and software could be a general purpose computer system with a computer program that, when being loaded and executed, controls the computer system such that it carries out the methods described herein.

Computer programs in the present context include any expression, in any language, code or notation, of a set of instructions intended to cause a system having an information processing capability to perform a particular function either directly or after conversion to another language, code or notation, and/or reproduction in a different material form.

Thus, the invention includes an article of manufacture which comprises a computer usable medium having computer readable program code means embodied therein for causing a function described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a function described above.

The computer readable program code means in the computer program product comprising computer readable program code means for causing a computer to effect one or more functions of this invention. Furthermore, the present invention may be implemented as a program storage device readable by machine, tangibly embodying a program of instructions executable by the machine to perform method steps for causing one or more functions of this invention.

It is noted that the foregoing has outlined some of the more pertinent objects and embodiments of the present invention. This invention may be used for many applications. Thus, although the description is made for particular arrangements and methods, the intent and concept of the invention is suitable and applicable to other arrangements and applications.

It will be clear to those skilled in the art that modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A method for privately broadcasting a video stream during an instantaneous witness deposition testimony via the Internet, comprising:
authenticating a host laptop computer;
capturing the witness deposition testimony via a video capture apparatus;
transmitting the captured deposition testimony to the host laptop computer;
encrypting the captured deposition testimony video stream for streaming via a remote server to an associate computer in a remote location;
decrypting the captured deposition testimony video stream from the host laptop computer for broadcasting on the associate computer; and
transmitting an instantaneous message between the host computer and the associate computer during the witness deposition testimony.

2. The method of claim 1, wherein a security dongle device is attached to the host laptop computer for login to the remote server and authenticating the host laptop computer, wherein the remote server transmits a first security token to the authenticated host laptop computer.

3. The method of claim 2, wherein the remote server transmits a first security token to the authenticated host laptop computer.

4. The method of claim 3, wherein the host laptop computer retrieves from the security dongle an ID code, and generates a two-key passphrase.

5. The method of claim 4, wherein the host laptop computer uses the two-key passphrase to encrypt the captured deposition testimony.

6. The method of claim 5, wherein the associate computer uses the two-key passphrase to decrypt and display the deposition testimony audio and video stream.

7. The method of claim 1, further comprising:
capturing the witness deposition testimony via a stenograph device;
capturing the witness deposition testimony via an audio recording device; and
transmitting a stenograph text, audio and video of the deposition testimony to the host computer,
wherein the stenograph text, audio and video of the deposition testimony are encrypted for streaming to the associate computer, and decrypted by the associate computer for broadcasting on the associate computer.

8. The method of claim 5, wherein the host laptop computer captures the deposition testimony video stream in JPEG format, and encrypts each JPEG file using the two-key passphrase.

9. A method of securely broadcasting a video stream of an instantaneous deposition testimony via an Internet network, the method comprising:
authenticating a subscribing user host computer to transmit instantaneous deposition testimony, and a subscribing user associate computer for receiving and broadcasting the instantaneous deposition testimony;
recording an instantaneous witness deposition via a stenograph device;
capturing an instantaneous witness deposition via a video and audio device;
receiving the instantaneous witness deposition video audio and text content by the subscribing user host computer;
encrypting the instantaneous witness deposition text; and
transmitting the encrypted video audio and text content via the Internet network to the subscribing user associate computer for instantaneous displaying therein.

10. The method of claim 9, wherein the instantaneous witness deposition video audio and text content is broadcast to the subscribing user associate computer for interactive communication with the subscribing user host computer during the deposition, wherein the user associate computer is located at a remote location from the deposition location.

11. The method of claim 9, wherein authenticating the subscribing user computer comprises:
inserting a security dongle into the subscribing user host computer for login and accessing a remote server via the Internet network;
retrieving from the security dongle an ID code, wherein the remote server authenticates the subscribing user host computer and transmits a first security token to the subscribing user computer; and
generating a two-key passphrase using the received first security token and the dongle ID,
wherein the two-key passphrase is used for secure broadcast transmission.

12. The method of claim 11, wherein the two-key passphrase is stored in the security dongle.

13. The method of claim 11, wherein authenticating the subscribing user associate computer further comprises:
accessing the remote server and requesting authorization from the subscribing user host computer for a peer-to-peer connection between the subscribing user host computer and the subscribing user associate computer,
wherein the subscribing user host computer authorizes the peer-to-peer connection and sends to the subscribing user associate computer the two-key passphrase, then the subscribing user associate computer receives an encrypted video, audio and text stream, decrypts the video, audio and text content stream using the two-key passphrase and displays the instantaneous witness deposition video audio and text on the subscribing user associate computer.

14. The method of claim 9, wherein the host laptop computer captures the deposition testimony video stream in JPEG format, and encrypts each JPEG file using the two-key passphrase.

15. The method of claim 9, further comprising:
transmitting an instantaneous message between the host computer and the associate computer during the witness deposition testimony,
wherein the transmitting computer encrypts each message using the two-key passphrase, then the receiving computer decrypts the message for display thereon.

16. A secure broadcasting system for an instantaneous deposition testimony, comprising:
a video and audio recording device for capturing the instantaneous deposition testimony;
a stenograph device for capturing the instantaneous deposition testimony;
a user host computer connected to the stenograph device;
a data transmission system, wherein the transmission system transmits an encrypted instantaneous deposition testimony video, audio and text via an Internet network; and
a user associate computer for receiving the encrypted video, audio and text content of the instantaneous deposition testimony at a remote location, decrypting the instantaneous deposition testimony and broadcasting the instantaneous deposition testimony.

17. The broadcasting system of claim 16, wherein the data transmission system comprises:
a security dongle attachable to the user host computer;
a software program that detects the attached security dongle and login to a remote server via the Internet network,
wherein the remote server authenticates the user host computer and transmits a first security token to the user host computer.

18. The broadcasting system of claim 17, wherein the user host computer retrieves from the security dongle an ID code and generates a two-key passphrase for encrypting the captured instantaneous video, audio and text.

19. The broadcasting system of claim 18, wherein when the user associate computer requests authentication from the user host computer for a peer-to-peer connection between the user host computer and the user associate computer, the user host computer sends the two-key passphrase to the user associate computer for decrypting the video, audio and text.

20. The broadcasting system of claim 19, wherein the user host computer is a laptop computer.
